(19) United States
(12) Patent Application Publication
(10) Pub. No.: US 2009/0280882 A1
(43) Pub. Date: Nov. 12, 2009

(54) System, method and computer program product for educational triva game

(76) Inventors: Hovakim Saghatelyan, Palos Verdes Estate, CA (US); Nerses Tumanyan, Palos Verdes Estate, CA (US)

Correspondence Address: Hovakim Saghatelyan, 2649 Via Valdes, Palos Verdes Estate, CA, 90274, US

(21) Appl. No.: 12/153,004

(22) Filed: May 9, 2008

(51) Int. Cl. G06F 17/00

(52) U.S. Cl. 463/9; 273/430

(57) ABSTRACT

A method and computer program product for an educational trivia game. The trivia game includes elements of gambling (i.e., placing bets) with an intense educational process and can be characterized as a method of unique edutainment. The trivia game of the present invention can be implemented in various forms such as, for example, a simple board game, a computer game, a DVD-based interactive game and a TV game show. The trivia game includes a playing board comprising three circles, three playing pieces of different colors, a timing piece (i.e., an hour glass or electronic timer), at least three sets of different color tokens (called Niqs) and at least three decks of trivia cards. A player who starts at point Zero (i.e., the initial point on the game board) and returns back to this point first, after going through all the steps of the three circles of the game board, becomes a winner. Alternatively, the last survivor of the game (when all other players run out of Niqs) also becomes a winner. In order to advance through the circles and reach the point Zero, a player must pay one Niq per each step.

### BACKGROUND OF THE INVENTION

1. Field of the Invention

The present invention is related to an educational trivia game, and more particularly, to a method, system and computer program product for implementing and playing the trivia game.

2. Background Art

The present invention is related to a trivia game, and more particularly, to a method, system and computer program product for implementing and playing an educational trivia game in various formats.

A number of various games of knowledge or intuition are known in which players compete with one another by attempting to respond correctly to questions related to a particular selected topic. Some trivia games have been adopted to a television game show format and have been very popular and successful. For example, in TV game show “Family Feud” family teams competed against one another by attempting to correctly answer questions relating to variety of topics. Based on the popularity and success of the “Family Feud” TV game show, a board game and DVD adaptations of the game show have also been introduced.

Various conventional trivia games are also known. For example Patent Application US 2007/0202937 A1 discloses a game of knowledge that includes wagering. The principles of wagering proposed follow conventional format of the game of poker.

Another example of trivia game is introduced in Patent Application US 2007/0202937 A1. This game includes cards having questions and more than one category of answers. The score is kept by awarding score pieces to players after they give the correct answer.

Yet another example of a conventional trivia game can be found in US Patent Application 2001/0015527 A1 describing trivia and betting board game. In the proposed game a player must successfully answer a question in order to collect on a bet and a player is given an opportunity to choose a response from a list of plausible answers. Other players are given an option to challenge a player and to place bets accordingly.

Still another conventional board trivia game is offered by U.S. Pat. No. 4,640,513. A memory educational game requires for players to spell, pronounce and define words correctly and answer questions cards. The play money is used to reward or penalize players for incorrect moves.

However, all of the conventional trivia games offer very little in terms of variety of trivia used and are geared towards a particular age group. The conventional trivia games rely on guessing and/or luck and offer limited educational values. Most of the known trivia games offer only one level of difficulty which makes them limited in terms of the age and educational level of players.

Accordingly, there is a need in the art for a comprehensive educational trivia game that can be of interest to players of different ages and educational backgrounds. There is also a need for a trivia game that can be conveniently implemented in various formats such as, for example, a board game, a computer game, a DVD-based interactive game and a TV game show. The educational advantages of the unique trivia game of the present invention will become apparent from the following description thereof.

### SUMMARY OF THE INVENTION

Accordingly, the present invention is related to an educational trivia game, and more particularly, to a method, system and computer program product for implementing and playing the trivia game in various formats, that substantially obviates one or more of the disadvantages of the related art.

In one embodiment, there is provided a method and computer program product for playing an educational trivia game. The proposed trivia game includes elements of gambling (i.e., placing bets) with an intense educational process and can be characterized as a method of unique edutainment. The trivia game of the present invention can be implemented in various forms such as, for example, a simple board game, a computer game, a DVD-based interactive game and a TV game show.

According to the preferred embodiment, a trivia game includes a playing board, three playing pieces of different colors, a timing piece (i.e., an hour glass or electronic timer), at least three sets of different color tokens (called Niqs) and at least three decks of trivia cards. Note, that an arbitrary number of decks of cards corresponding to various topics can be used. Additional new trivia cards can be acquired from game manufacturer.

The principle of the game, in accordance with the exemplary embodiment, is as follows. A player who starts at point Zero (i.e., the initial point on the game board) and returns back to this point first, after going through all the steps of the three circles of the game board, becomes a winner. Alternatively, the last survivor of the game (when all other players run out of Niqs) also becomes a winner. In order to advance through the circles and reach the point Zero, a player must pay one Niq per each step.

The player earns Niqs for advancing forward by paying for steps. The player must make a bet on one of the multiple choice answers provided for each question on the trivia card. A player wins more Niqs by providing the correct answer to the question of the trivia card. Thus the game provides a philosophical aspect similar to real life, where the winner has not only to demonstrate knowledge, but also has to take more chances by placing risky bets.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a trivia game board in accordance with the exemplary embodiment.

FIG. 2 illustrates a trivia card in accordance with the exemplary embodiment.

FIG. 3 illustrates implementation of a Zero card in accordance with the exemplary embodiment.

FIG. 4 illustrates a main flow chart of the trivia game in accordance with the exemplary embodiment.

FIG. 5 illustrates a flow chart of the “Regular Play” in accordance with the exemplary embodiment.

FIG. 6 illustrates a flow chart of the “Duel Play” in accordance with the exemplary embodiment.

FIG. 7 illustrates a flow chart of the “Fatum Play” in accordance with the exemplary embodiment.

FIG. 8 illustrates a flow chart of the “Blind Play” in accordance with the exemplary embodiment.

FIG. 9 illustrates a flow chart of the “Shortcut Play” in accordance with the exemplary embodiment.

FIG. 10 illustrates an exemplary computer system on which the trivia game can be implemented.

### DETAILED DESCRIPTION OF THE PREFERRED EMBODIMENTS

Reference will now be made in detail to the preferred embodiments of the present invention, examples of which are illustrated in the accompanying drawings.

According to the preferred embodiment a system, method and computer program product for playing an educational trivia game are provided. A trivia game includes a playing board, three playing pieces of different colors, a timing piece (i.e., an hour glass or electronic timer), at least three sets of different color Niqs (i.e., tokens) and at least three decks of trivia cards.

An arbitrary number of decks of trivia cards corresponding to various topics can be used. Note that additional new trivia cards can be acquired from the game manufacturer. Therefore, the same trivia game can be played differently every time. In other words, with the new decks of trivia cards the game never gets old and continues to offer new challenges to players of all levels.

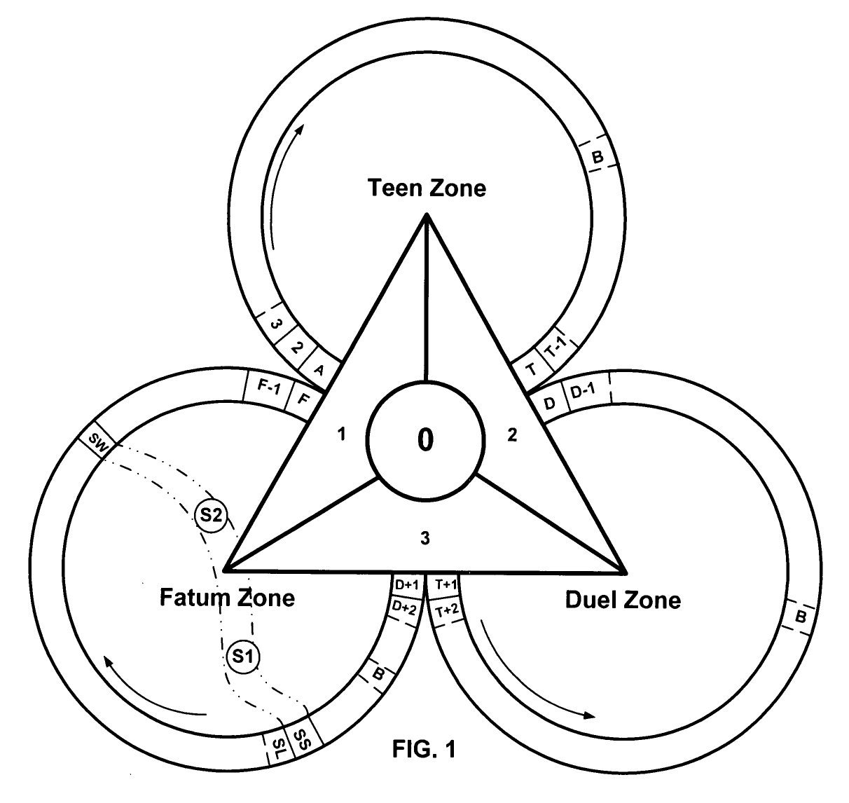

The general principle of the trivia game, in accordance with the exemplary embodiment, is as follows. A player who starts at point Zero (i.e., 0—the initial point on the game board depicted in FIG. 1) and returns back to this point first, after going through all the steps of the three circles of the game board, becomes a winner. The trivia circles are Teen Circle, Duel Circle and Fatum Circle are shown in FIG. 1. Alternatively, the last survivor of the game (when all other players run out of Niqs) also becomes a winner. In order to advance through the circles and reach the point Zero (see FIG. 1), a player must pay one Niq per each step. In FIG. 1: mark A specifies the first step play point, B—specifies location of the blind point, T stands for the number of Teen Zone steps (T can be any number T=k*7, where k=1, 2, 3 . . . ), D is a number of Duel Zone steps (D=T+7), F is a number of Fatum Zone steps (F=D+7) and also F stands for the last step play point.

SS is shortcut play starting point, SL is a shortcut loosing destination point, S1 is a first step of a shortcut play, S2 is a second step of a shortcut play, SW is a shortcut play winning destination point. The numbers 1, 2 and 3 located on the triangle are the zones for placing bets corresponding to the numbers (i.e., 1 is a betting zone corresponding to the answer #1, 2—for the answer #2 and 3—for the answer #3). The direction of the play in each of the circles is shown by arrows. The number of bets is limited for each zone. A maximum amount of bets in Teen circle equals the minimum bets in Duel Circle and the maximum in Duel Circle equals the minimum in Fatum Circle.

The player advances forward by paying for steps with Niqs. The player must make a bet on one of the multiple choice answers provided for each question on the trivia card. A player wins more Niqs by providing a correct answer to a question of the trivia card. The player advances forward on the board by paying for steps. The player must make a bet on one of the multiple choice answers that are provided for each question on the trivia card. A player wins more Niqs by providing the correct answer to the question of the trivia card. Thus, the game provides a philosophical aspect similar to real life, where the winner has not only to demonstrate knowledge, but also has to take more chances by placing risky bets.

The unique philosophical aspect of the game is provided by the following principles:
1) Each player starts the game with a different start-up capital (i.e., a number of Niqs) similar to real life situation where a person gets a certain initial status provided by education, place of residence, family money etc. The initial status of a player is defined in “Zero” card in a random manner.
2) Regardless of the initial number of Niqs, during the game some players have a chance to win thanks to a “Lucky 4” game. Thus, each player ultimately has an equal chance at winning. It all depends on his or her game (i.e., knowledge, ability to take appropriate risk etc.).
3) During real life a person goes through different life cycles that test the person in different ways and according to different rules. In the proposed game the life cycles are represented by different trivia circles that have different rules. The trivia circles also have trivia questions of different degree of difficulty. The trivia questions used in each trivia circle can cover various topics.
4) In the proposed trivia game, just like in real life, acquiring money (i.e., Niqs) is not the main goal, but just the means to achieving the life long goal. In other words, in the game when player makes money he needs to spend them in order to advance forward.
5) Each person, a group or an educational organization, using simple and effective method of the proposed trivia game, can create its own set of specific trivia questions for particular educational tasks performed in the game environment that is similar to real life. Anyone can be a Master of the game or can add variation to game rules.

A more detail explanation of the method and principles of playing the trivia game will be provided herein.

A trivia game, according to the preferred embodiment, can be played by two to three players and one Master of the game (i.e., dealer). Alternatively, the game can be played by three teams with up to three players on each team. Thus, unlike in conventional trivia games, nine people can be involved in the game concurrently. A Master can be a volunteer or one of the older players who take turns. Preferably the Master should be a parent or an experienced player. In case of a team play, it is preferred that each team has an older more experienced leader. When the trivia game of the preferred embodiment is played as a TV show, the team can consist of a player (or a group of players) on stage and a group from the audience. In this case, the players on stage can consult with their respective team members from the audience. Thus, the TV show trivia game is implemented as an interactive educational and fun environment. Alternatively, players on stage can consult with the TV viewers, by having the members of the TV audience call the show, send emails or SMSs, etc.

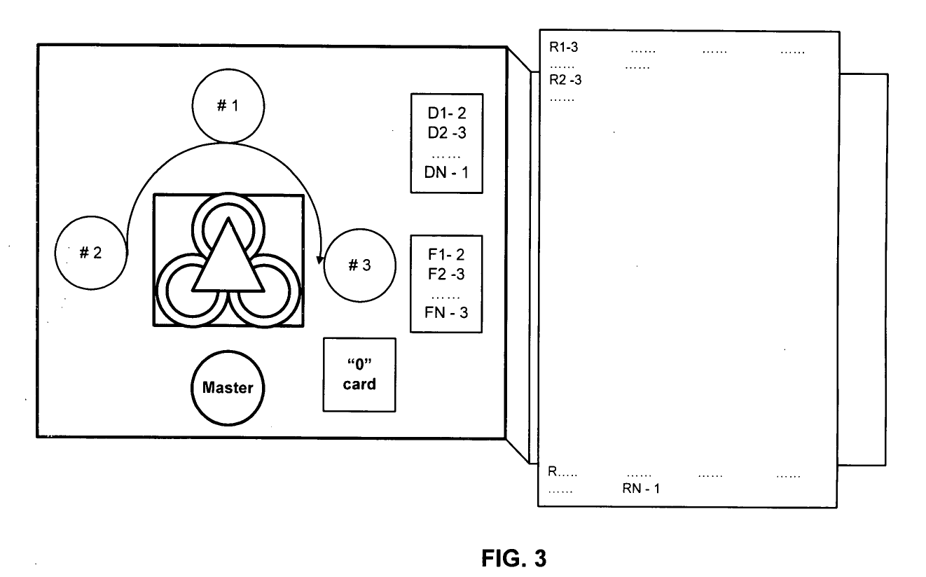

In case when the trivia game of an exemplary embodiment is played as a regular board game, all players must have a seat around the table in the center of which the game board depicted in FIG. 1 is positioned. After the Master is determined, he reads the vow of the master out loud and then discusses the rules of the game with the players (unless all of the players are already familiar with the rules). Placement of the players and the Master around the board is shown in FIG. 3.

According to the exemplary embodiment, players select a particular Deck of the Trivia Cards. The selection of the Deck of Trivia Cards can be made by voting. Subsequently the Master opens selected (i.e., voted for) Deck of Trivia Cards. Note that a Deck of Trivia Cards can be played only once by the same group of players. Therefore, new Decks of Trivia Cards can be acquired from the trivia game manufacturer. Those of ordinary skill in the art would appreciate that the trivia game of the exemplary embodiment never “gets old” and advantageously continues to bring educational value to the players with each round played.

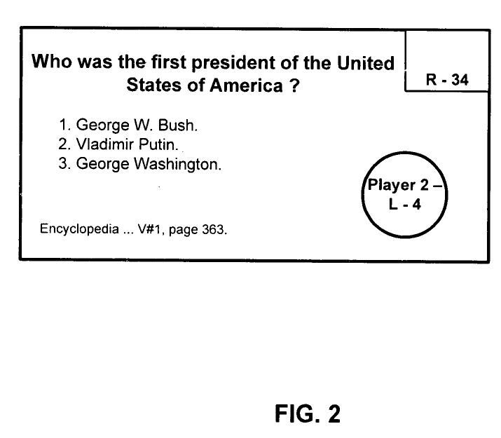

An exemplary Trivia Card from the Deck is illustrated in FIG. 2. Each Trivia Card in the Deck (except card #0, i.e., Zero card) has one question and three multiple choice answers (see FIG. 2). One of these is the correct answer. The source of the correct answer is provided in the reference area of the Trivia Card. In the exemplary card depicted in FIG. 2, the source is Encyclopedia . . . Volume 1. An exemplary Trivia Card from the Deck illustrated in FIG. 2 has a mark in the right corner. This mark specifies if it is a Regular (R), a Duel (D) or a Fatum (F) card. A number specifies the number of the card in the deck.

Trivia Multiple Choice Questions in each Deck of Trivia Cards can be encompass various fields of art and science. For example they can include all areas of science, religion, art, modern life, history, anatomy, geography, law, IQ questions, Grammar, Math etc., with Magnet (i.e., emphasis) placed in certain area. In case when the Trivia Game is played as a TV show, the Trivia questions can be displayed on a large screen located on stage. So the entire studio audience at the show, as well as viewers at home, can see the question and the multiple choice answers. Alternatively, questions and answers can be presented to viewers in a form of images and/or video clips. According to the exemplary embodiment, the Trivia Multiple Choice Questions are educational and entertaining at the same time.

Note that the Trivia Multiple Choice Questions in each deck have three levels of difficulty:
Regular (relatively easy questions, about 91 cards) shown as R in FIG. 3;
Duel (medium difficulty questions, 6 cards) shown as D in FIG. 3, and
Fatum (hard questions, 3 cards) shown as F in FIG. 3.
   Alternatively any arbitrary number of cards of each level can be used. First card on top of each deck is #0-Zero card depicted in FIG. 3. According to the preferred embodiment, this card must be seen by the Master only.

A Zero card tells the Master the order of players for playing the game and provides the answers to all Trivia Multiple Choice Questions. Other cards provide the correct answer numbers as shown in FIG. 3. For example, F2-3 means that a correct answer for the Fatum question #2 is the answer #3 or D1-2 means that a correct answer for the Duel question #1 is the answer #2, The Zero card must be kept strictly confidential in order to maintain integrity of the game. All Regular cards are numbered (from 1 to 91) and located on the top of the deck (1^{st} color). The Duel cards are located after the regular cards (2^{nd} color). The Fatum cards are located at the bottom of the deck (3^{rd} color).

Each Deck has two collectible Niqs (a Gold Niq for a winner and Silver Niq for the Master). The Gold Niq is only awarded to the winner, while the Silver Niqs are granted as a token of appreciation for helping and guiding others to play the game in fun and educational environment. So a Master gets the Silver Niq automatically. Some Trivia Cards have the Lucky 4 mark. The player, who gets a Trivia Card with a Lucky 4 mark (see L-4 in FIG. 2), may bet up to 4 additional Niqs during that current round of Trivia Questions regardless of his turn to play.

After opening the new Deck, the Master takes out the Zero card from the top of the Deck. Based on the info provided on the Zero card the Master passes out the playing pieces along with the certain amount of Niqs to the players. Unlike the conventional games, in the Trivia Game of the exemplary embodiment, each player (or a team of players) receives a different amount of betting Niqs. According to the exemplary embodiment, First player (or a team) receives 14 Niqs, second player/team −21 Niqs, third player/team—28 Niqs. Please note that an arbitrary number of Niqs can be used as long as the number of Niqs given to each team differs by the same increment. For example, if the first player/team gets X Niqs, the second player gets −X+K and third player/team receives −X+2K.

All players must put their playing pieces into the central area, i.e., Zero Point of the playing Board as shown in FIG. 1. The players are responsible for moving their playing pieces during the game under supervision of a Master. The Master opens a first regular card. A Lucky 4 mark (see L-4 in FIG. 2) may be found on the card referring to a particular player. It can be an active player who can buy steps right after this round of the game or it can be a passive player who has a right to earn more Niqs during this round, but cannot buy steps at this point. Master announces the Lucky 4 to the players.

The number one player (i.e., an active player) or a team (as defined by a Zero card) always starts the game first, and then everybody plays clockwise. In this case, a player number one is considered an active player. The Master reads the question with the three multiple choice answers out loud. Note that an arbitrary number of multiple choice answers can be used. After that the Master passes the card to the next active player and starts a timer set at 20 seconds. Alternatively, different timers set for different time intervals can be used. Also different timeout intervals can be set for each of the trivia circles shown in FIG. 1. Initially a player number one is an active player—i.e., a player who is supposed to play next according to a Zero card.

During the timeout period of 20 seconds an active player must answer the question by placing the bet of up to 3 Niqs (in case of Lucky 4 card the player may bet up to 7 Niqs) on his choice of answer in the triangle (see FIG. 1). The player can place his bet on either 1^{st}, 2^{nd} or 3^{rd} zone (each zone refers to the multiple choice answer with the corresponding number, for example, a bet placed in zone three means that the player bets on answer 3).

If the player does not make a choice and place a bet in 20 seconds he loses his current turn with the right to buy a step after this particular turn. During the next 20 second all other players should bet clockwise 1 Niq each. In case of Lucky 4 the player may bet up to 5 Niqs. After everybody has placed their bets, the Master reads the correct answer out loud and gives everyone who has chosen the right answer (by putting bets on a particular zone) the same amount of Niqs they bet. Nobody is allowed to change his answer after the bet was placed. The Master keeps the remaining Niqs from the triangle area. Please not that timeout can be set at any length of time smaller or greater than 20 seconds used in the exemplary embodiment.

The first player (i.e., an active player) must buy up to 3 steps by paying 1 Niq per step. Only an active player for this round is allowed to buy steps, by paying the Master and subsequently moving his playing piece forward. In the first circle of the Trivia Game called Teen circle (shown in FIG. 1) consisting of T steps, betting is made by as described above. The only exception is step number B (see B marks in FIG. 1) called the Blind number. If a player chooses to stop at Blind number, he is allowed to bet blindly up to 3 Niqs out of turn. In the exemplary embodiment number 13 is used as blind step. Note that in alternative embodiment the Teen circle can consist of an arbitrary number of blind points. In the exemplary embodiment T equals 14.

After player places his bets, the Master reads the question and the multiple choice answers. If the player, by chance, got the right answer he wins 3 times the amount of Niqs he has already bet. But player cannot move further on the circle. There are two more blind steps in the exemplary embodiment, numbers 26 and 39, with the same rules as number 13. If the player does not want (or chooses not to) to play blind he must skip the blind steps. Alternatively, an order and the numbers of blind steps can be chosen differently. Note that other, non-active players, are allowed to play the Blind Play according to the rules of the Regular Play.

In the second circle of the game, Duel circle (see FIG. 1) consisting of D steps, betting may be made by two methods. First method is the same as the one employed in the Teen circle. The second method, called Duel, is used as following. The players who get to the Duel circle are allowed (one time), while their playing piece is located in the Duel circle, to duel (i.e., challenge) each of the other players a total of two times. Note that a Duel circle of an alternative embodiment can consist of an arbitrary number of steps. In the exemplary embodiment D equals 21.

A Duel must be announced by the player before the Master reads the next Trivia Question. During the Duel each player is playing only against his opponent. The Master must take one of the duel cards from the Trivia Deck and read it loud. Then each player has 20 seconds to place a bet. A challenger and an opponent (i.e., Dueler) may bet up to 7 Niqs each (with minimum duel bet of 3). A challenger is considered an active player in Duel game and is allowed to buy steps. Note that a number of allowed bets can also be chosen differently in an alternative embodiment of the trivia game.

The Master announces the winning answer only after the players match each others bets.

For example, a player number 1 bets 3 on answer number 2, his opponent may either match the bet or he can overbid the player. If the player decides to overbid his opponent, the challenger must either match the bet, or place a higher bet, or step out of Duel and loose the next turn clockwise. This rule has to be enforced by the Master. In case when one of the players does not have enough Niqs to match the opponent's bet, he plays with all the Niqs he has (i.e., play “all-in”). The Challenger must receive the amount of Niqs matching to his winning bet and he can buy any number of steps equaling to a number of Niqs he has bet even if he looses. The Challenger losses his right to buy steps only if he exceeds the timeout or decides to quit the game.

In the 3^{rd} circle of the game, called Fatum circle (see FIG. 1) consisting of F steps, betting is made by the same method as one employed in the Teen circle. Note that the Duel method is not allowed if the player is in the Fatum circle. In this circle a player is allowed to take Fatum play against Master once. The player can also play the Shortcut game only once, and play a mandatory Last Question play. F in the exemplary embodiment equals 28.

The player who desires to play Fatum must announce it when his turn comes. This player is considered an active player for the Fatum game and thus he can buy steps. In the Fatum game only one player plays against the Master. In this case, the Master must take a card from the bottom of the Trivia Deck and read it loud. Note that the Master is already aware of the answer to the Fatum question. The player is allowed to bet up to 21 Niqs (with a minimum bet of 7) on the answer of his choosing. There is a timeout set for this game. The Master must match or may overbid (in case the bet of the player is less than 21 Niqs) the player by betting on appropriate answer area. Bluffing by the Master is strongly encouraged at this point in order to create more fun and make betting more interesting and intense. Alternatively, a Master can be not aware of the answer and he reveals the right answer by scratching the particular area of a Zero card. The Fatum game has a set time limit. Alternatively, different maximum and minimum bets can be used.

The active player is allowed to change his mind and change the answer until he announces his final answer by matching the Master's bet or betting “all-in.” If the active player wins the Fatum game, he is allowed to buy as many steps as many Niqs he has bet, up to 21 step. If the player looses—he can still advance further, but he can only buy a number of steps corresponding to the number of bets he made. If the player refuses or decides to skip the Fatum play he will loose the Niqs he has already bet. He will also loose his right to buy steps at the current turn, but he never looses his next turn.

The Shortcut play is allowed to all players who have reached the step number SS (see FIG. 1). After an active player gets to the step number SS he must play Shortcut play on his next turn. In the Shortcut play, a player must answer three regular questions one after another and still place bets. The Master takes three Regular questions from the top of the Trivia Deck and asks the first question.

The player bets up to three Niqs and answers the first question. If he answers this question correctly, he must proceed to the next question without taking his winnings (provided by the Master) and move the playing piece to the point S1. The player bets the same way the second time and if he answers correctly, he must move the playing piece to the point S2. If all three questions are answered correctly by the player, he proceeds to the number SW—Shortcut Winner (see FIG. 1) and takes all his winnings. No more steps are allowed to be bought.

If the player gets one of the three questions wrong he looses all the Niqs he bet and returns to the step number SL—Shortcut Looser (see FIG. 1) and not allowed to buy any more steps. Other non-active players may play during the Shortcut play according to the rules of the Regular play. When a player reaches step number F he must stop (the player is not allowed to jump over it) and play the Last Question play on his next turn. The Master reads a regular question and the player must answer it in order to complete the circle and win the game. If the player gets a correct answer, he is considered to have won the game. The Last Question play is played by an active player only, and non-active players are not allowed to place bets during the Last Question play.

Other Rules of the Last Question play are similar to the Teen Circle rules. The player may be considered a winner in another case as well when the other players run out of Niqs while he still has some left, regardless of the step where the player is at this point.

In one embodiment the trivia game can be implemented as a computer game. In this embodiment a Master can be implemented as a virtual Master being part of the software. Different decks of trivia cards can be bought and downloaded from the game producer. The game can be played by different players remotely. In this scenario the game application is executed on the server and each player can seat at his computer and log onto the game and can play remotely against real or virtual players.

In another embodiment the trivia game can be provided on the CD ROM or another similar carrier. In yet another embodiment the trivia game application can be downloaded onto player's computer from a game server. The trivia game of the present invention can also be used in a TV show or can be played on stage with the input from the audience. In case of the Trivia Game being played as a TV show, the show Host serves as a Master of the game and the members of the audience can be assigned to different players on stage as a support team.

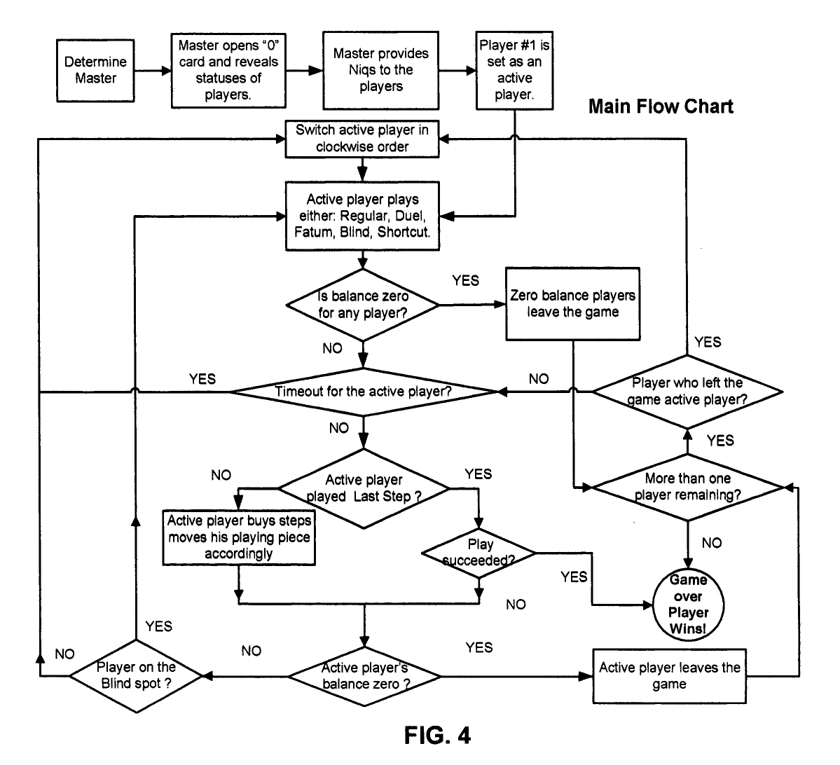

The algorithms used for computer implementation of the trivia game are provided in FIGS. 4-9. FIG. 4 illustrates a main flow-chart of the game in accordance with the exemplary embodiment. The following global variables are created for the software implementation of the game:

MIN_STEP—minimum step, in the exemplary embodiment MIN_STEP=1;
MIN_REM_PLAYERS—minimum remaining players, in the exemplary embodiment

MIN_REM_PLAYERS=2;

MIN_REG_BET—minimum regular bet, in the exemplary embodiment MIN_REG_BET=1;

MAX_REG_BET—maximum regular bet, in the exemplary embodiment MAX_REG_BET=3;

ANSW_NUM—a number of multiple choice answers, in the exemplary embodiment ANSW_NUM=3;

BLIND_MUL—a number of blind points, in the exemplary embodiment BLIND_MUL=3;

LUCKY_N—a lucky number, in the exemplary embodiment LUCKY_N=4;

SHORTCUT_LEN—a length of a shortcut, in the exemplary embodiment SHORTCUT_LEN=3;

MAX_DUEL_BET—a maximum duel bet, in the exemplary embodiment MAX_DUEL_BET=7;

MAX_FATUM_BET—a maximum fatum bet, in the exemplary embodiment MAX_FATUM_BET=21;

TIMEOUT—in the exemplary embodiment TIMEOUT=20 seconds;

ACT_TME—a time allowed to an active player, in the exemplary embodiment, ACT_TIME=20 seconds;

NONEACT_TIME—a time allowed to a non-active player, in the exemplary embodiment NONEACT_TIME=5 seconds;

FATUM_TIME—timeout in the Fatum play, in the exemplary embodiment

FATUM_TIME=30 seconds. In alternative implementations of the trivia game these variables can be assigned different values.

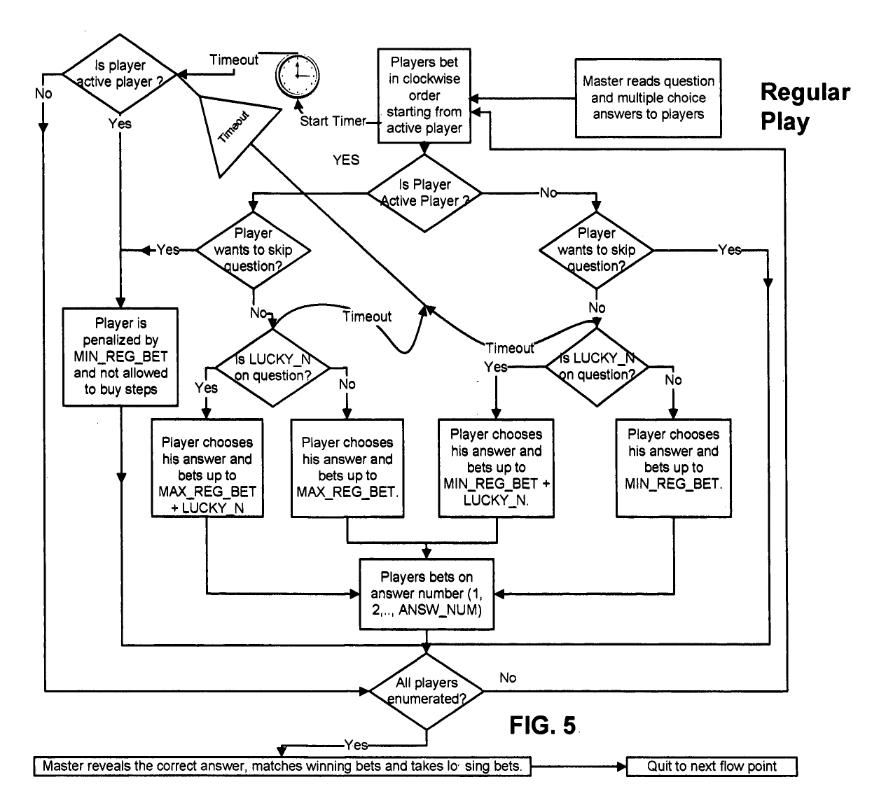

FIG. 5 illustrates a flow chart of a regular play that is played in the Teen Circle. The timeouts ACT_TIME and NONEACT_TIME are set.

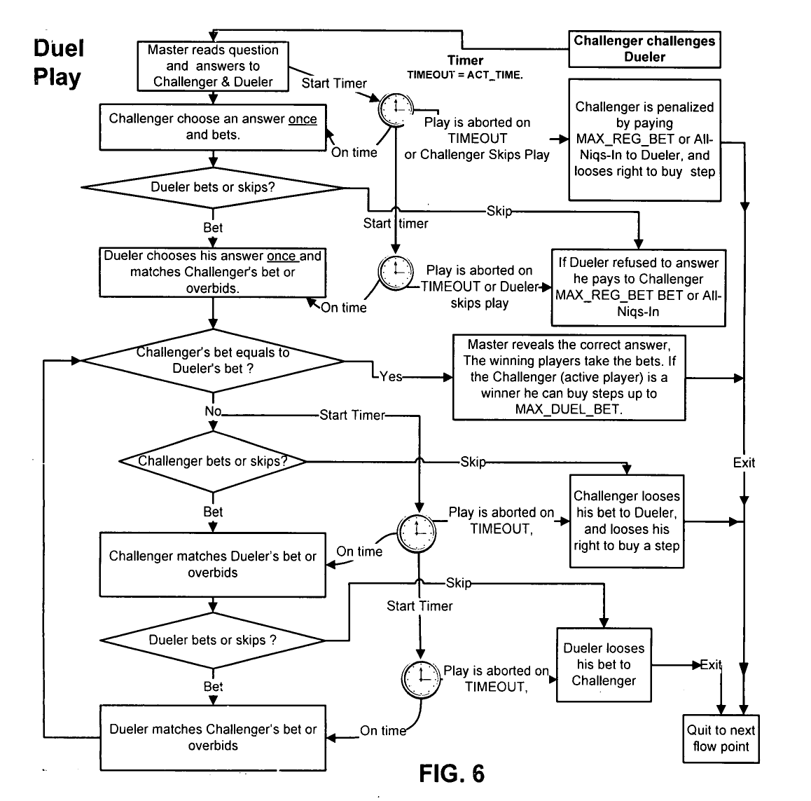

FIG. 6 illustrates a flow chart of the Duel play in accordance with the exemplary embodiment. The timeouts is set at ACT_TIME.

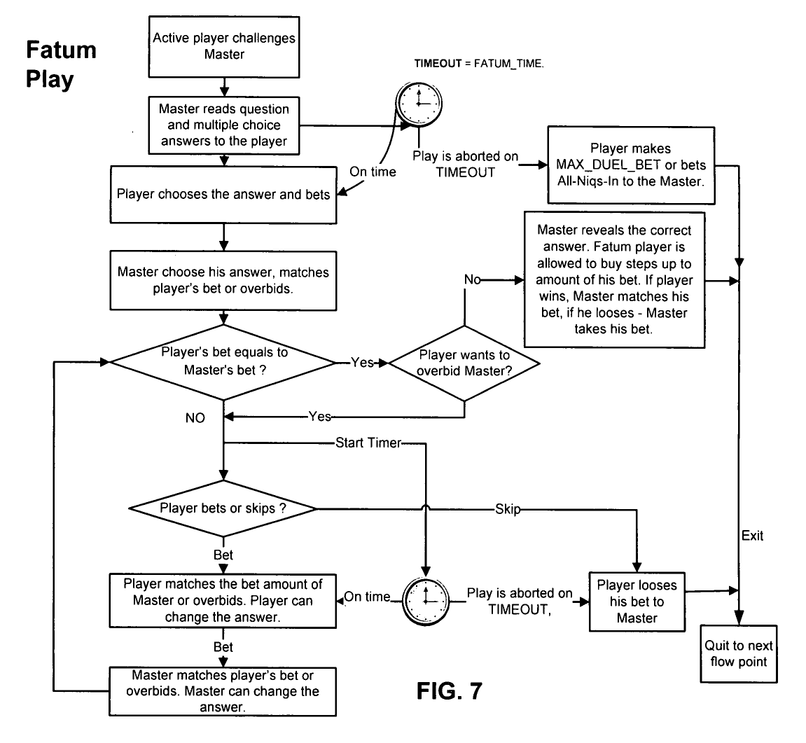

FIG. 7 illustrates a flow chart of the Fatum play in accordance with the exemplary embodiment. The timeouts is set at FATUM_TIME. Minimum allowed bets in Fatum play equal MAX_DUEL_BET. If the player has amount of Niqs less than MAX_DUEL_BET, he can bet All-Niqs-In. Maximum Fatum bet equals MAX_FATUM_BET. If the player has amount of Niqs less than MAX_FATUM_BET he can bet All-Niqs-In. The Master and the active player can change their answers as many times as they place bets.

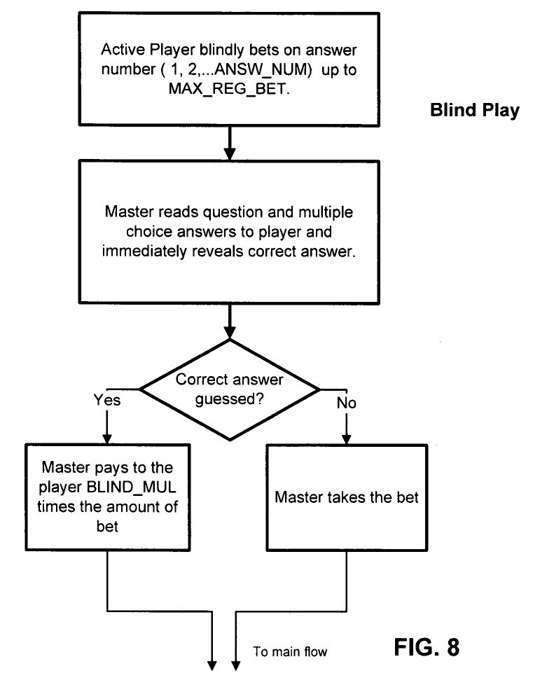

FIG. 8 illustrates a diagram of the Blind play in accordance with the exemplary embodiment. The Master pays to the player BLIND_MUL times of the amount of bet.

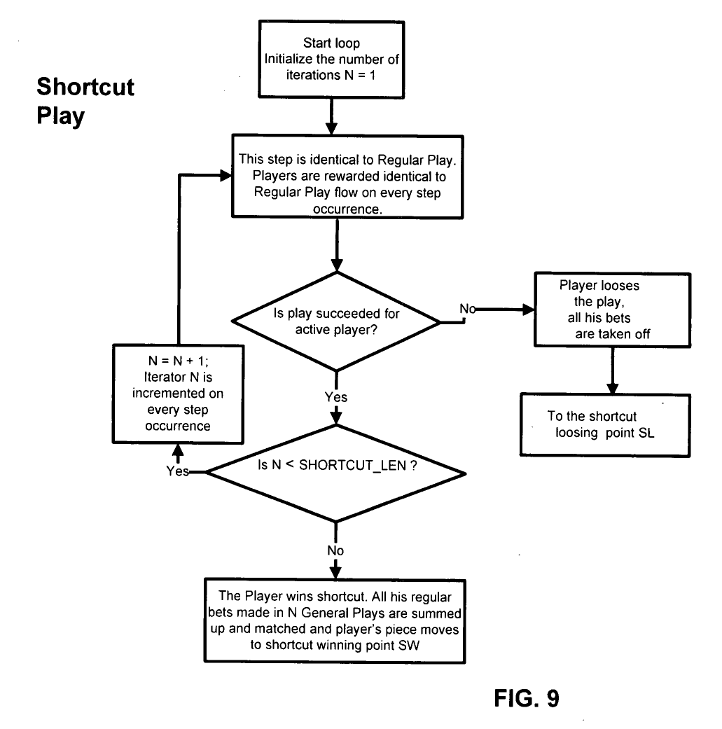

FIG. 9 illustrates a flowchart of the Shortcut Play in accordance with the exemplary embodiment. If player wins the Shortcut Play his game piece is moved to shortcut winning point on the circle SW (see FIG. 1) and if he losses—the game piece is moved to shortcut loosing point SL (see FIG. 1).

Those of ordinary skill in the art would appreciate that the Trivia Game of the exemplary embodiment provides a philosophical aspect similar to real life situations, where the winner not only has to demonstrate the knowledge, but also has to take chances by placing risky bets in order succeed in the game.

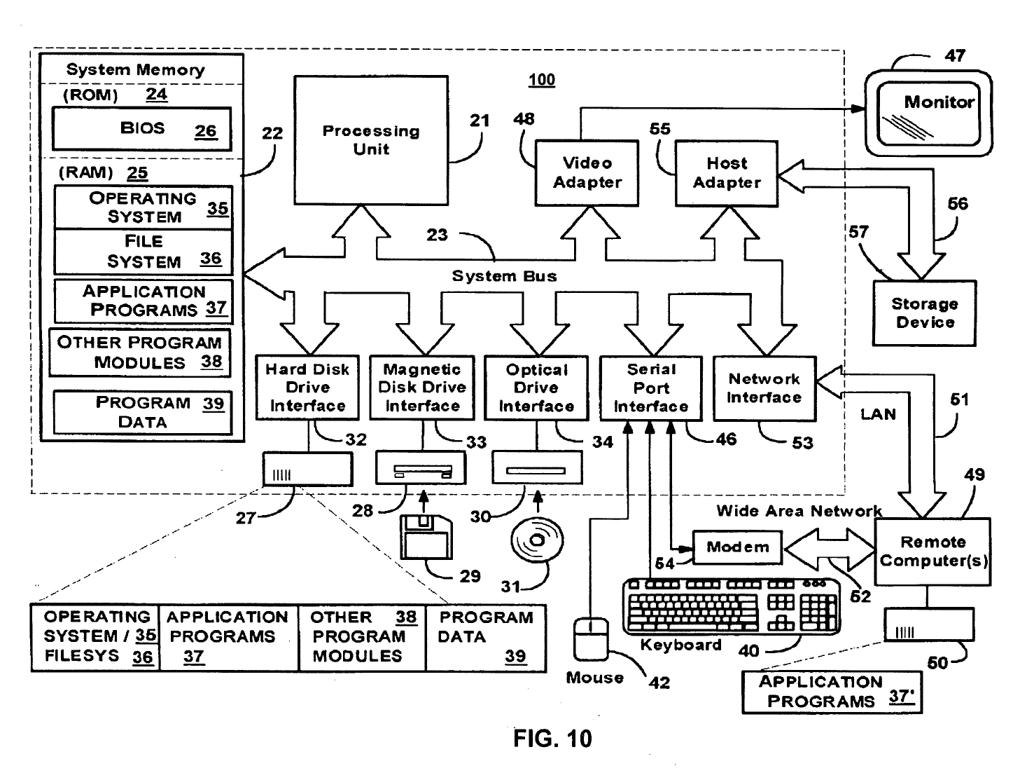

With reference to FIG. 10, an exemplary system for implementing the invention includes a general purpose computing device in the form of a computer or a server 100 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures.

The system memory includes read-only memory (ROM) 24 and random access memory (RAM) 25. A basic input/output system 26 (BIOS), containing the basic routines that help to transfer information between elements within the computer 100, such as during start-up, is stored in ROM 24. The computer 100 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD-ROM, DVD-ROM or other optical media.

The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the computer 100.

Although the exemplary environment described herein employs a hard disk, a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35 (preferably Windows™ 2000). The computer 100 includes a file system 36 associated with or included within the operating system 35, such as the Windows NT™ File System (NTFS), one or more application programs 37, other program modules 38 and program data 39. A user may enter commands and information into the personal computer 100 through input devices such as a keyboard 40 and pointing device 42. Other input devices (not shown) may include a microphone, joystick, game pad, satellite dish, scanner or the like.

These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers.

When used in a LAN networking environment, the personal computer 100 is connected to the local network 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the computer 100, or portions thereof, may be stored in the remote memory storage device. It will be appreciated that the network connections shown are exemplary and other means of establishing a communications link between the computers may be used.

Having thus described a preferred embodiment, it should be apparent to those skilled in the art that certain advantages of the described method and computer program product have been achieved. In particular, it should be appreciated by those skilled in the art that the trivia game of the present invention provides not only for advanced entertainment, but also achieves a very significant educational advantage for its participants, regardless of the game format used.

It should also be appreciated that various modifications, adaptations, and alternative embodiments thereof may be made within the scope and spirit of the present invention. The invention is further defined by the following claims.

What is claimed is:

1. An educational trivia game comprising:
a game board having a plurality of trivia circles and a betting area, each of the trivia circles is divided into a number of steps;
a plurality of trivia cards having a question and a plurality of answers written thereon;
a timing device for setting a play timeout;
a plurality of play tokens for being given to players;
a plurality of game pieces to be used by the players for advancing through the steps along the trivia circles,
wherein the tokens are used by the players for making bets on the answer from the trivia card and wherein the bets are placed on a segment of the betting area corresponding to the answer the players wish to bet on.

2. The trivia game of claim 1, wherein the players are given different amounts of the play tokens.

3. The trivia game of claim 1, wherein the timing device is any of:
an hour glass;
an electronic timer;
a mechanical timer; and
a computer implemented timer.

4. The timing device of claim 3, wherein the timeout is set for a different period for each of the trivia circles.

5. The trivia game of claim 1, wherein the trivia cards are divided into decks according to a level of difficulty of the questions presented on the cards.

6. The trivia game of claim 5, wherein a different deck of the trivia cards is used for each of the trivia circles.

7. The trivia game of claim 1, wherein the players can move around the trivia circles using the play tokens.

8. The trivia game 7, wherein the players can buy the steps using the play tokens.

9. The trivia game of claim 1, wherein each of the trivia circles has its own set of game rules.

10. The trivia game of claim 1, wherein the players win the play tokens when they bet on a correct answer from the trivia cards and loose tokens when they bet on a wrong answer.

11. A method for playing an educational trivia game, the method comprising:
(a) choosing a Master from a plurality of players for a round of a play;
(b) providing a plurality of decks of trivia cards and selecting the deck for the round of play;
(c) determining, by the Master, a turn for each player;
(d) providing, by the Master, a plurality of play tokens and game pieces to each player;
(e) setting a timeout period on a timing device;
(f) reading, by the Master, a question and a plurality of answers to the players from the trivia card;
(g) placing bets by each of the players according to their turns;
(h) announcing the correct answer, by the Master and awarding the players who bet on a correct answer with the play tokens and keeping the play tokens of the players who bet on a wrong answer;
(i) moving the game pieces, by the players, along the trivia circle according to a rule of this circle; and
repeating steps (f)-(i) for the next trivia card from the deck.

12. The method of claim 11, wherein selecting the deck for the round of play is done by voting.

13. The method of claim 11, wherein the turn for each player is determined by a special trivia card of the selected deck.

14. The method of claim 11, wherein the players pay for steps for moving along the trivia circle with the play tokens.

15. The method of claim 14, wherein the play tokens are earned by betting.

16. The method of claim 14, wherein the play tokens are given to the players by the Master at a start of the game.

17. A computer useable recording storage medium having computer program logic stored thereon for executing on a processor for implementing an educational trivia game, the computer program logic comprising:
computer program code means for displaying a game board comprising a plurality of trivia circles and a betting area to players;
computer program code means for displaying a plurality of trivia cards;
computer program code means for implementing a virtual Master of the trivia game;
computer program code means for providing a plurality of virtual play tokens to the players;
computer program code means for allowing the players to move around the trivia circles to a predetermined number of steps; and
computer program code means for allowing the players to place bets in the betting area of the displayed game board.

18. The computer program logic of claim 17, wherein the virtual Master displays correct answers and awards or detracts the virtual play tokens to and from the players.

19. The method of claim 11, wherein the trivia game is played on a stage of a TV show.

20. The method of claim 19, wherein the Master is the TV show Host and the players are members of a studio audience.
